(19) United States
(12) Patent Application Publication
(10) Pub. No.: US 2007/0252836 A1
(43) Pub. Date: Nov. 1, 2007

(54) Region of interest selector

(75) Inventors: George K. Mathew, Waukesha, WI (US); Pankaj Bhaskar, Pewaukee, WI (US); Terry Paul Chang, San Jose, CA (US)

Correspondence Address: GE MEDICAL SYSTEM;C/O FOLEY & LARDNER LLP, 777 EAST WISCONSIN AVENUE, MILWAUKEE, WI, 53202-5306, US

(73) Assignee: General Electric Company

(21) Appl. No.: 11/413,500

(22) Filed: Apr. 28, 2006

(51) Int. Cl. G09G 5/22

(52) U.S. Cl. 345/440.1

(57) ABSTRACT

A method for producing a region of interest on an image of a medical signal waveform acquired from a patient displayed on a computer screen includes the steps of receiving interaction to move through the image of the medical signal waveform; displaying guidelines on the image to define a region of interest; acting upon data in the region of interest; and displaying the image, the acted upon data, and the defined region of interest on the computer screen.

### FIELD OF THE INVENTION

The present invention relates generally to the field of a selectable region of interest and specifically to a region of interest on an image of a medical signal waveform acquired from a patient, such as is obtained from a heart.

### BACKGROUND OF THE INVENTION

During a cardiac catheterization procedure, pressures inside different heart chambers are measured using a hemodynamic catheter inserted through an artery. In addition, echocardiogram (ECG) waveforms are monitored using electrodes attached to the body surface. Sampled ECG and pressure data is collected and the corresponding waveforms displayed on a hemodynamic monitoring system. The monitoring system can automatically calculate the systolic, diastolic, end-diastolic pressures for a given beat, and the mean pressure over a number of beats. In addition, pressure gradients across heart valves can be measured.

These measurements are typically performed on data collected over a predetermined duration. Measurements are performed on all the beats within this duration. This can be problematic since it is often the case that not all the data within this duration is relevant. For example, it may be desirable to measure pressures on end-expiratory beats only. Once the measurement has been performed, it is tedious to edit measurement results manually to remove the results for beats that are not desired.

Thus, there is a need for a monitoring system that allows the user the ability to easily indicate a measurement region in order to increase the efficiency and the accuracy of measurements. There is also a need for a method of indicating a measurement region in order to increase the efficiency and accuracy of measurements.

### SUMMARY OF THE INVENTION

One embodiment of the invention relates to a method for producing a region of interest on an image of a medical signal waveform acquired from a patient displayed on a computer screen. The method includes the steps of receiving instructions to move through the image of the medical signal waveform; displaying guidelines on the image to define a region of interest; and acting upon data in the region of interest. The method includes displaying the image with the acted upon data, and the defined region of interest on the computer screen.

Another embodiment of the invention relates to a tool to produce a region of interest on an image of a medical signal waveform acquired from a patient displayed on a computer screen. The tool includes a mechanism configured to obtain the image of the medical signal waveform; means for receiving instructions to move through the image; means for displaying guidelines on the image to define a region of interest; and means for calculating data in the region of interest. The tool displays the image, the calculated data and the defined region of interest on the computer screen.

### BRIEF DESCRIPTION OF THE DRAWINGS

FIG. 1 is a schematic view of a medical signal system, for example a hemodynamic monitoring system according to one example embodiment.

FIG. 2 is a flow chart of a method for producing a region of interest in the system of FIG. 1 on an image of a waveform according to one example embodiment.

FIG. 3 is a waveform displayed on a computer screen with a region of interest produced in the system of FIG. 1 according to one example embodiment.

FIG. 4 is a waveform displayed on a computer screen with the measured data refined using a region of interest produced in the system of FIG. 1 according to one example embodiment.

### DETAILED DESCRIPTION OF THE EXAMPLE EMBODIMENTS

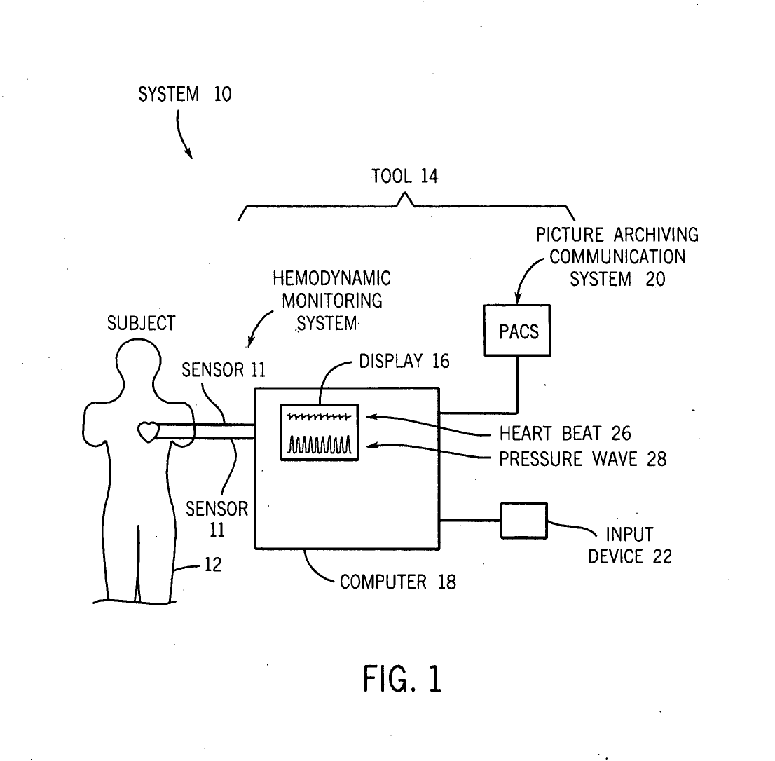

Referring to FIG. 1, hemodynamic monitoring system 10 is configured to take and display various measurements, such as ECG or pressure data, that may be manipulated by a user. It is noted that while the illustrated example embodiment shows a hemodynamic monitoring system, in other example embodiments, a medical signal acquired from a patient that can be displayed in a waveform on monitoring systems of various types, such as oxygen transport or medication transport monitoring systems for example, may be used. System 10, generally includes a sensor 11 and a tool 14. Sensor 11 is coupled to a subject 12, either invasively or non-invasively. In another example embodiment, more than one sensor may be utilized for taking measurements. While subject 12 is shown to be a human in the illustrated example embodiment, subject 12 may be another animal or anatomical structure in other example embodiments such as a dog, cat, or horse. In still other example embodiments non-animal subjects may be monitored.

Tool 14 is configured to produce a region of interest on an image of a medical signal waveform, for example a pressure waveform, displayed on a computer screen 16. Tool 14 may be coupled to subject 12 via sensor 11, for example a catheter, in order to obtain information such as cardiovascular and pressure data from subject 12. While tool 14 is shown to measure and display pressure information in the illustrated example embodiment, in other example embodiments other information such as oxygen transport or medication transport data may be measured and displayed. Tool 14 generally includes a computer 18, an archive 20, and an input device 22.

Computer 18 is coupled to subject 12 and is a mechanism that obtains information such as cardiovascular data from subject 12 and processes it for display on computer screen 16. In an example embodiment where cardiovascular data is displayed, heart beat and blood pressure waveforms may be displayed. In other example embodiments, numerical data, such as of pressure data values for example, may be present in addition to the waveforms or in place of the waveforms. Computer 18 may allow for manipulation of the displayed information by a user. In various example embodiments, computer 18 may be of any past, present, or future form suitable for processing information such as cardiovascular data.

Archive 20 is coupled to computer 18 and is generally configured to store data retrieved by computer 18 from subject 12 for later manipulation by a user. In various example embodiments, archive 20 may be of any appropriate type for storing data to be used by computer 18. In one example embodiment, archive 20 may be a picture archiving communication system that stores data in a picture format suitable for transmission to and from computer 18. In another example embodiment archive 20 may store non-picture related data such as numerical data. In other example embodiments archive 20 may be one or more hard-drives, one or more local or remote servers, a raid array, or some other recordable and readable media such as a rewritable CD, DVD, or floppy disk. In various example embodiments transmission of data to and from archive 20 may be over a hardwire network, a fiber-optic network, or a wireless network.

Input device 22 is coupled to computer 18 and serves as an interface for a user to manipulate information obtained by computer 18 from subject 12. In one example embodiment, input device may be a mouse usable to graphically manipulate data processed by computer 18. In other embodiments, input device 22 may be a joystick, track-wheel, keyboard, voice recognition device, touch screen, light pen, remote control, or other suitable device.

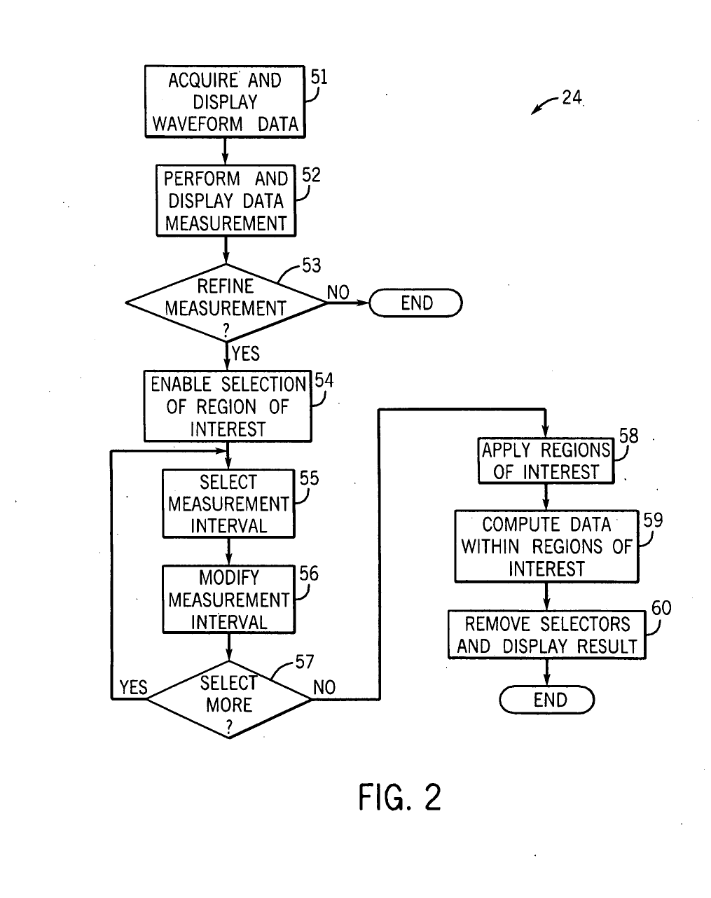

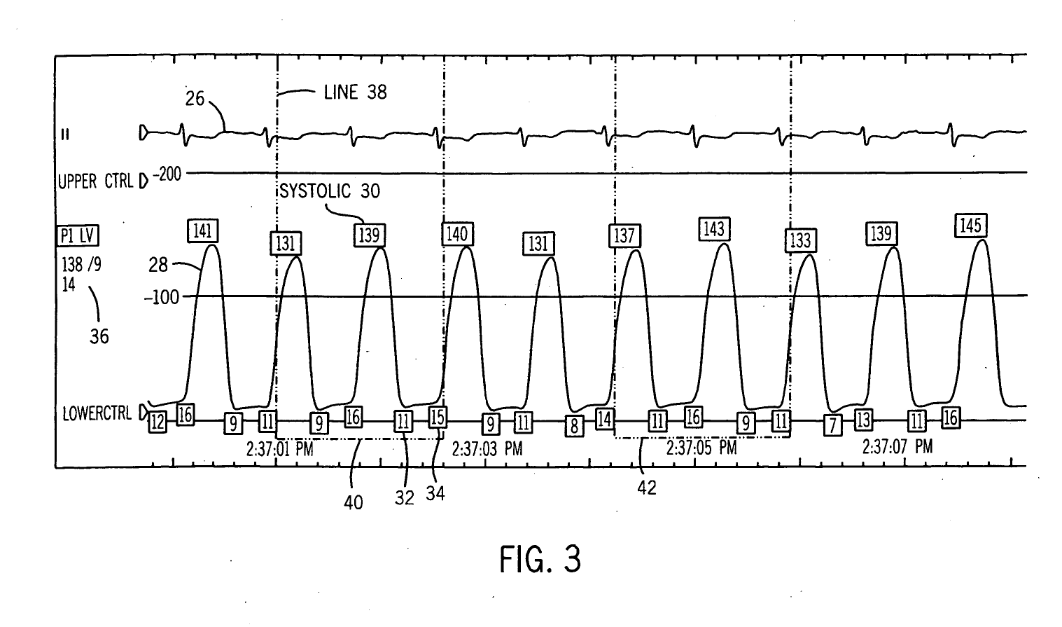

Referring to FIG. 2-4, flowchart 24 describes the steps a system may take to manipulate data obtained from subject 12. Waveforms 26 and 28 are example ECG and pressure waveforms that may be displayed on computer screen 16. At step 51 waveform data such as waveforms 26 and 28 are acquired from subject 12 and displayed. It should be understood that any type of medical signal waveform acquired from a patient can be manipulated with the tool and method described herein. The system can be operated by a user who will provide instructions to the system.

At step 52 the system may perform a pressure measurement. In various example embodiments, the hemodynamic or pressure measurements taken may be related to ventricular measurements, atrial measurements, arterial measurements, or any combination thereof. In these example embodiments, ventricular measurements may be used in systolic, diastolic, or end-diastolic calculations; atrial measurements may be used in atrial systole, atrial filling, or mean calculations; and arterial measurements may be used in systolic, diastolic, or mean calculations. In one example embodiment, this measurement may be performed using a measure icon from a graphical toolbar while in another example embodiment a keyboard shortcut may be used. This action measures displayed beats (i.e. peaks and valleys), and places marks, such as systolic mark 30, diastolic mark 32, and end-diastolic mark 34, on pressure waveform 28. A sidebar 36 on the left of waveforms 26 and 28 may show overall measurement results, averaged over each acquired sample.

At step 53, the system decides whether or not to further refine the overall measurements by selecting only a smaller portion of the sampled data or by excluding portions of the sampled data. If the user does not wish to refine the measurements, then no further action needs to be taken.

At step 54, the system may enable the selection of a region of interest (ROI) in order to refine the overall measurements. In one example embodiment, this measurement may be performed using an ROI button from a graphical toolbar while in other example embodiments a keyboard shortcut or other method may be used. Once the ROI function is enabled, the user can select a number of intervals within the sampled data to select portions to be included in the overall measurements.

At step 55, the system may select each interval as desired. In an example embodiment where input device 22 is a mouse, the user may click the mouse inside the screen displaying the pressure waveform to identify a left point of the desired interval. A graphical indicator, such as line 38, is displayed, prompting the user to click the mouse once again at a different point, to select the right point of the desired interval. Once both points are identified, the ROI selector, such as ROI selector 40, may be drawn connecting the two points. In one example embodiment, the ROI selector may be U-shaped to indicate the interval, while in other example embodiments the selector may be of any other appropriate shape or simply two lines passing through each endpoint of the interval.

At step 56, the system can further modify the position and extent of the ROI selector. In an example embodiment where input device 22 is a mouse and the ROI selector is of a U-shape, this modification may be accomplished by moving either endpoint independently by clicking and dragging on the vertical lines, or by moving the entire ROI selector by clicking an dragging on the bottom horizontal line of the U-shape.

At step 57, the system may repeat steps 55 and 56, until the desired number of ROI selectors are drawn within the pressure waveform at the appropriate locations. In the illustrated example embodiment, two ROI selectors 40 and 42 were drawn within the pressure waveform.

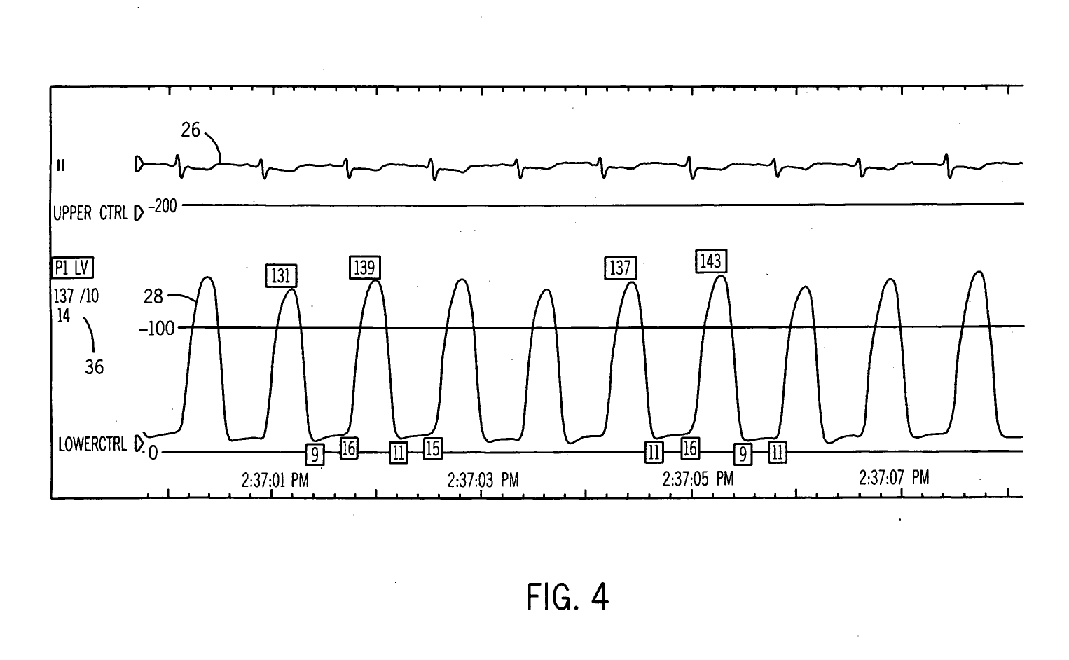

At step 58, the system may narrow the overall measurements by applying each ROI. In on example embodiment where input device 22 is a mouse, this application may be done by clicking an ROI button on a graphical toolbar for a second time. The system may then remove the pressure measurement marks outside the selected region-of-interest, such as in FIG. 4.

At step 59, depending on the embodiment, the systolic, diastolic and/or end-diastolic pressure values for the overall measurement are recomputed to be the average of all the corresponding pressure values for all the beats within the selected regions of interest. In one exemplary embodiment, the mean pressure value for the overall measurement may be recomputed based on the collected samples within the selected regions of interest. In various other exemplary embodiments, ventricular measurements may be used in systolic, diastolic, or end-diastolic calculations; atrial measurements may be used in atrial systole, atrial filling, or mean calculations; and arterial measurements may be used in systolic, diastolic, or mean calculations.

At step 60, the ROI selectors may be removed from display as illustrated in FIG. 4, for example. The overall result may be displayed on a sidebar such as sidebar 36 and the ROI calculations may be saved to archive 20. In one exemplary embodiment, once an ROI calculation has been saved to an archive server, a user may later modify the calculations using a remote client workstation networked to archive 20.

It is noted that in another example embodiments including pressure measurement, other measurements may also be made such as pressure gradients across heart valves. In other example embodiments, the above steps may be performed on other types of measured data such as for valve area measurements. In an example embodiment for valve area measurements, two different pressure waveforms, on either side of a heart valve, may be used to measure valve function. The same steps as above may be used to select a portion of the waveforms to be used for valve area measurements. When the ROI is applied, pressure gradient and valve area results are recomputed based on the beats within the selected region of interest.

While the above described example embodiments show ROI selectors being placed within pressure data after a pressure measurement, in other example embodiments, ROI selectors may be placed prior to performing a pressure measure measurement. Thus, in various example embodiments, measurements may be taken in either real-time or on previously saved data.

Although monitoring system 10 is illustrated as including multiple features utilized in conjunction with one another, monitoring system 10 may alternatively utilize less than all of the noted mechanisms or features. For example, in other example embodiments, archive 20 may be omitted with ROI selection occurring only in real-time. In still other embodiments, step 57 may be omitted with only one ROI selector being usable at a time.

Although specific shapes of each element have been set forth in the drawings, each element may be of any other shape that facilitates the function to be performed by that element. For example, the ROI selectors are shown to define a U-shaped area, however, in other embodiments the structure may define that of a relatively circular form or a form without a bottom connecting line.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally defined as a single unitary body with one another or with the two components or the two components and any additional member being attached to one another. Such joining may be permanent in nature or alternatively may be removable or releasable in nature

The present disclosure has been described with reference to example embodiments, however workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. Other substitutions, modifications, changes and omissions may be made in the design, operating conditions and arrangement of the preferred and other exemplary embodiments without departing from the spirit of the present subject matter.

What is claimed is:

1. A method for producing a region of interest on an image of a medical signal waveform acquired from a patient displayed on a computer screen, comprising the steps of:
receiving instructions to move through the image of the medical signal waveform;
displaying guidelines on the image to define a region of interest;
acting upon data in the region of interest; and
displaying the image with the acted upon data, and the defined region of interest on the computer screen.

2. The method of claim 1, including the step of changing the image being acted upon.

3. The method of claim 1, including the step of reconfiguring the guidelines.

4. The method of claim 1, including the step of storing the displayed image.

5. The method of claim 1, including the step of annotating the displayed image in the defined region.

6. The method of claim 1, wherein the displayed image of the medical signal waveform is one selected from a group consisting of ventricular, atrial, and arterial waveforms.

7. The method of claim 6, wherein the medical signal waveform is from an anatomical structure.

8. The method of claim 7, wherein the anatomical structure is a human heart.

9. The method of claim 8, wherein the mechanism is a hemodynamic monitoring system.

10. The method of claim 1, wherein the step of receiving instructions includes inputs from an input device selected from a group consisting of a mouse, a joystick, a keyboard, a track ball, a touch screen, a voice recognition control and a light wand

11. A tool to produce a region of interest on an image of a medical signal waveform acquired from a patient displayed on a computer screen, the tool comprising:
a mechanism configured to obtain the image of the pressure waveform;
means for receiving instructions to move through the image;
means for displaying guidelines on the image defining a region of interest;
means for calculating data in the region of interest; and
displaying the image, the calculated data, and the defined region of interest on the computer screen.

12. The tool of claim 11, including a means for changing the image being acted upon.

13. The tool of claim 11, including a means for reconfiguring the guidelines.

14. The tool of claim 11, including a means for storing the displayed image.

15. The tool of claim 11, including a means for annotating the displayed image in the defined region.

16. The tool of claim 11, wherein the displayed image in one selected from a group consisting of ventricular, atrial and arterial waveforms.

17. The tool of claim 16, wherein the medical signal waveform is from an anatomical structure.

18. The tool of claim 17, wherein the anatomical structure is a human heart.

19. The tool of claim 18, wherein the mechanism is a hemodynamic monitoring system.

20. The tool of claim 11, wherein the means for receiving instructions includes an input signal from an input device selected from a group consisting of a mouse, a joystick, a keyboard, a track ball, a touch screen, a voice recognition control and a light wand.
